(19) United States
(12) Patent Application Publication
(10) Pub. No.: US 2012/0297411 A1
(43) Pub. Date: Nov. 22, 2012

(54) COMMUNICATION SYSTEM AND COMMUNICATION METHOD

(75) Inventor: Akihiko Koizuka, Tokyo (JP)

(73) Assignee: DWANGO CO., LTD., Tokyo (JP)

(21) Appl. No.: 13/393,894

(22) PCT Filed: Nov. 19, 2010
(86) PCT No.: PCT/JP2010/070679

§ 371 Date: Mar. 2, 2012

(30) Foreign Application Priority Data
Dec. 4, 2009 (JP) 2009-276309

(51) Int. Cl. H04N 21/43

(52) U.S. Cl. 725/24

(57) ABSTRACT

In a communication system in which comments that are input following the progress of played contents are shared between a plurality of user terminals, for each comment which is transmitted from a user terminal, a comment server associates comment attribute information which shows the attributes of the comment with comment identifying information and stores these and extracts from the plurality of stored comments those comments which have comment attribute information specifying that they are to be delivered to the user terminal, and delivers these to the user terminal. When a comment which follows the playing of contents is input, the user terminal transmits to the comment server that comment and the comment attribute information which shows the attributes of the comment and which it has itself transmitted.

### TECHNICAL FIELD

The present invention relates to a communication system and a communication method in which comments that are input so as to match the progress of played contents are shared between a plurality of user terminals.

Priority is claimed on Japanese Patent Application No. 2009-276309, filed Dec. 4, 2009, the contents of which are incorporated herein by reference.

### BACKGROUND ART

Communication services are available to deliver comments transmitted from a plurality of user terminals that are connected together via a network, and provide a site for communication between users. For example, Patent document 1 discloses a chat service to which a large number of user terminals can connect. Moreover, in recent years, communication services have been provided that share between a plurality of user terminals comments which are input into the user terminals following the progress of contents being played on the user terminals, so that these are displayed on a contents screen.

### DOCUMENTS OF THE PRIOR ART

### Patent Documents

[Patent document 1] Japanese Unexamined Patent Application, First Publication No. H10-334021

### DISCLOSURE OF INVENTION

### Problem to be Solved by the Invention

However, in a communication service of this kind, even if all of the comments transmitted from a large number (for example, tens of thousands) of user terminals are delivered to all of the user terminals, it is difficult for the users of the user terminals who receive this huge number of comments to read and comprehend all of the comments. Furthermore, in this case, an excessive load is placed on the comment server, the network, and the user terminals and the like. For this reason, it may be thought that it is difficult for communication between users to be established in some cases. Therefore, performing control so as to limit the number of comments that are delivered to a user terminal so that no more than a fixed number of comments are delivered to the user terminal can be considered. If the number of comments that are delivered is limited in this manner, then rather than indiscriminately thinning out the comments delivered to a user terminal, it is more desirable to extract comments that enable communication to proceed smoothly between users and allow these to be delivered.

The present invention was conceived in view of the above described circumstances. The present invention provides a communication system and a communication method that, at the same time as they are reducing the number of comments that are delivered to user terminals, extract comments that enable communication to proceed smoothly between users and deliver these comments.

### Means for Solving the Problem

In order to solve the above described problems, a communication system according to the present invention includes a plurality of user terminals, and a comment server that stores in a comment storage section comments which are transmitted from the user terminals in response to contents which are played on the user terminals, and delivers the comments to the plurality of user terminals to be displayed thereon, wherein the comment server includes: a comment attribute information storage section that stores comment identifying information which identifies the comments stored in the comment storage section and comment attribute information which shows attributes of the comments in association with each other; a comment information registering section that receives the comments and the comment attribute information associated with the comments transmitted from the user terminals, and stores the comment identifying information for the comments and the comment attribute information in association with each other in the comment attribute information storage section; a comment extracting section that extracts the comments which are indicated by the comment attribute information to be delivered to the user terminals from among the plurality of comments stored in the comment storage section; and a comment delivery section that delivers to the user terminal the comments extracted by the comment extracting section, and wherein the user terminal includes: an attribute information storage section that stores the comment attribute information showing attributes of the comments to be transmitted: an input section that receives the comments input in response to the contents being played; and a comment transmitting section that transmits to the comment server the comments input in response to the contents being played, and the comment attribute information stored in the attribute information storage section.

In the communication system of the present invention, the comment server may include a comment attribute information defining section that selects, from a plurality of items of the comment attribute information, an item of comment attribute information to be stored in association with comment attached in response to the contents when the contents are selected by the user terminal, and the attribute information storage section in the user terminal may stores the comment attribute information which matches the item selected by the comment attribute information defining section.

Moreover, the communication system of the present invention may include a user management server which stores user attribute information showing attributes of the user corresponding to the user terminal, and the attribute storage section in the user terminal stores the user attribute information read from the user management server as the comment attribute information.

Moreover, in the communication system of the present invention, the user terminals may include a comment attribute management section that receives the comment attribute information input by the user, and stores the input comment attribute information in the attribute information storage section.

Moreover, in the communication system of the present invention, the comment delivery section in the comment server may deliver to the user terminals the comments extracted by the comment extracting section, and the comment attribute information stored in association with the comment, and the user terminal may include an output control section that alters displaying of the comment in response to the comment attribute information stored in association with the comment.

Furthermore, according to the present invention, a communication method in a communication system having a plurality of user terminals and a comment server that has a comment storage section which stores comments transmitted from the user terminals in response to contents which are played by the user terminals and delivers the comments to the plurality of user terminals, including the steps of: receiving, in the comment server, the comments and comment attribute information which is associated with and indicative of attributes of the comments from the user terminals; storing, in the comment attribute information storage section, comment identifying information which identifies the comments and the comment attribute information in association with each other; extracting, in the comment server, the comments which are indicated by the comment attribute information to be delivered to the user terminals from among the plurality of comments stored in the comment storage section; delivering, in the comment server, the extracted comments to the user terminals; storing, in the user terminals, the comment attribute information showing attributes of the comments to be transmitted in the attribute information storage section: receiving, in the user terminals, the comments input in response to the contents being played; and transmitting, in the user terminals, the comments input in response to the contents being played, and the comment attribute information stored in the attribute information storage section to the comment server.

### Effect of the Invention

As has been described above, according to the present invention, in a communication system in which comments that are input following the progress of played contents are shared between a plurality of user terminals, for each comment which is transmitted from a user terminal, a comment server associates the comment with comment attribute information which shows the attributes of the comment and stores them, and extracts from the plurality of stored comments those comments which have comment attribute information specifying that they are to be delivered to the user terminal, and delivers these to the user terminal. When a comment is input in accordance with the contents being played, the user terminal transmits to the comment server that comment as well as the comment attribute information which shows the attributes of that comment to be transmitted by itself. Accordingly, it is possible for the user terminal to receive from among the plurality of comments stored in the comment server only those comments which have specified comment attribute information and to display only these. By doing this, the number of comments displayed on a user terminal can be restricted to a number that a user is able to more easily comprehend, and it can be anticipated that communication will be able to proceed smoothly between users. Moreover, because it is possible for the number of comments transmitted from the comment server to be reduced in comparison with when all of the comments are delivered from the comment server, it is possible to limit the loads placed on the comment server, the network, and the user terminals and the like.

### BRIEF DESCRIPTION OF THE DRAWINGS

FIG. 1 is a block diagram showing a communication system according to an embodiment of the present invention.

FIG. 2 is a view showing an example of data stored in a comment attribute information storage section according to an embodiment of the present invention.

FIG. 3 is a view showing an example of a screen displayed on a user terminal according to an embodiment of the present invention.

FIG. 4 is a sequence diagram showing an example of an operation of the communication system according to an embodiment of the present invention.

### EMBODIMENTS FOR CARRYING OUT THE INVENTION

Hereinafter, an embodiment of the present invention will be described with reference made to the drawings.

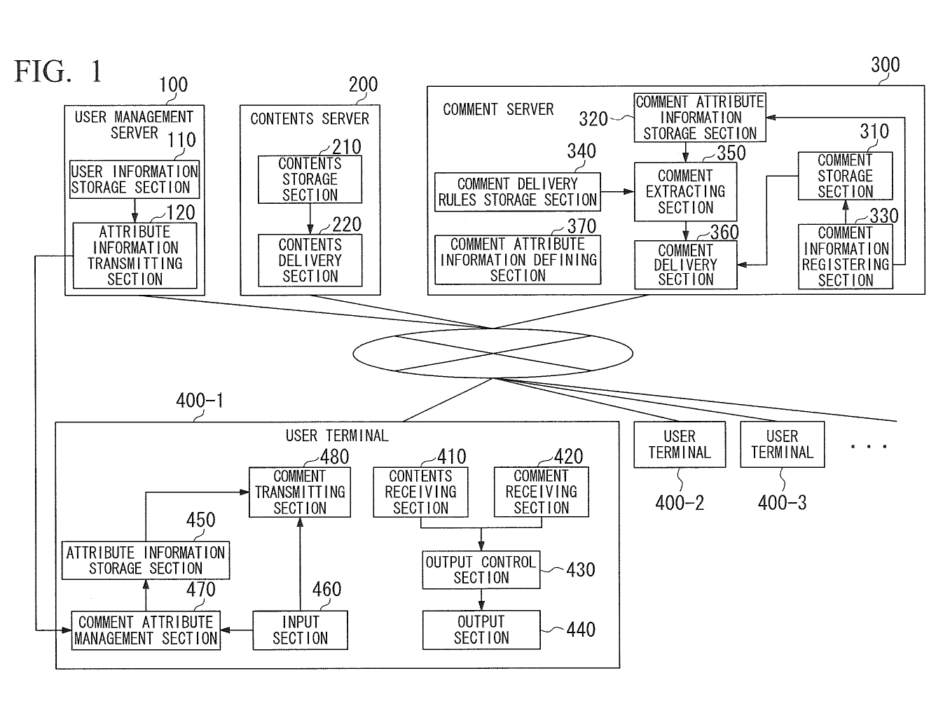

FIG. 1 is a block diagram showing the structure of a communication system 1 according to the present embodiment. The communication system 1 is provided with a user management server 100, a contents server 200, a comment server 300, and a plurality of user terminals 400 (i.e., a user terminal 400-1, a user terminal 400-2, a user terminal 400-3, . . . a user terminal 400-n, . . . a user terminal 400-N). These component elements are formed by computer devices and are connected together via a network. Here, because the plurality of user terminals 400-N (wherein N is an arbitrary integer) have the same structure, other than when any special distinction is to be made, the generic descriptor ‘user terminals 400’ is used.

The user management server 100 is a computer device that receives from the user terminals 400 connection requests to connect to a communication service which is provided by the contents server 200 and the comment server 300. The user management server 100 is provided with a user information storage section 110, and an attribute information transmitting section 120.

The user information storage section 110 associates user identification information which identifies the user of a user terminal 400 with user account information, and with user attribute information which shows the attributes of that user, and then stores such associations as user information. The user account information is registered in advance for users to use the communication service, and includes information such as the user account name, password, and the like. Information such as, for example, the user's handle name, date of birth, gender, blood type, address, and the like is included in the user attribute information.

The user management server 100 performs login processing for users by collating user account information transmitted from the user terminals 400 with account information stored in advance in the user information storage section 110. For example, if user account information that matches the user account information transmitted from the user terminal 400 is stored in the user information storage section 110, the login is determined to be successful, and connection destination information which enables it to establish a connection with the contents server 200 and the comment server 300 is delivered to the user terminal 400. As a result, utilization of the communication service by the user terminal 400 is permitted. If, on the other hand, user account information that matches the user account information transmitted from the user terminal 400 is not stored in the user information storage section 110, the login is determined to have failed, and utilization of the communication service is not permitted.

The attribute information transmitting section 120 transmits to a user terminal 400 whose login is determined to have been successful user attribute information which corresponds to the user of that user terminal 400. Here, it is also possible for the attribute information transmitting section 120 to refer to comment delivery rules which are stored in a comment delivery rules storage section 340 (described below), and, from the user attribute information, to only transmit user attribute information for particular items which are predetermined in each contents. The user attribute information transmitted by the attribute information transmitting section 120 to the user terminals 400 is used as comment attribute information which is attached thereto when the user terminal 400 transmits a comment to the comment server 300.

The contents server 200 is a computer device that delivers contents that are played by the user terminals 400. The contents server 200 is provided with a contents storage section 210 and a contents delivery section 220.

The contents storage section 210 stores contents that are delivered to the user terminals 400 and are played thereon. The contents that are stored in the contents storage section 210 include information such as video or audio that follows a time axis. The contents stored in the contents storage section 210 may be information that is stored in advance, or may be information that is created in real time. For example, the information may be video information about a cooking program that has been previously recorded, or may be video information about a baseball game that is input in real-time by a live broadcast.

The contents delivery section 220 delivers the contents stored in the contents storage section 210 in accordance with contents delivery requests transmitted from the user terminals 400.

The comment server 300 is a computer device that receives comments transmitted from the user terminals 400 in accordance with contents played by the plurality of user terminals 400, and then delivers the received comments to the plurality of user terminals 400 so that they are displayed thereon. The comment server 300 is provided with a comment storage section 310, a comment attribute information storage section 320, a comment information registering section 330, the comment delivery rules storage section 340, a comment extracting section 350, a comment delivery section 360, and a comment attribute information defining section 370.

The storage section 310 associates comment identifying information which identifies comments transmitted from the user terminals 400 with comments which are in the form of text information, and stores them. The comment storage section 310 may also be provided with comment storage areas (i.e., threads) which are different for each item of contents delivered to the user terminals 400. It is also possible to provide a plurality of threads for a single contents item.

The comment attribute information storage section 320 associates comment identification information which identifies comments stored in the comment storage section 310 with comment attribute information which shows comment attributes, and stores such associations.

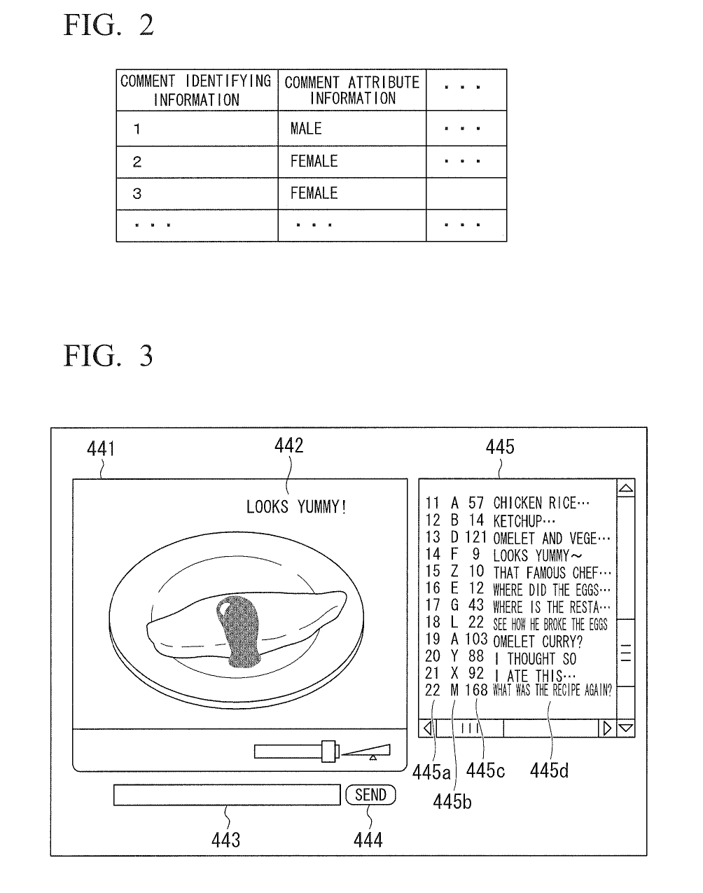

FIG. 2 shows an example of comment attribute information data which is stored in the comment attribute information storage section 320. Here, an example is shown in which the gender is stored as comment attribute information. For example, [male] is associated with comments whose comment identifying information is [1], and these associations are stored as the comment attribute information.

The comment information registering section 330 receives comments, and also the comment attribute information associated with those comments from the user terminals 400, and creates comment identifying information identifying the received comments which it then stores together with the comments in the comment storage section 310. For example, sequential numbers or the like can be used for the comment identifying information. In addition, the comment information registering section 330 also associates created comment identifying information with received comment attribute information, and stores such associations in the comment attribute information storage section 320.

Comment delivery rules, which are applied when the plurality of comments stored in the comment storage section 310, are delivered based on the comment attribute information, are stored in the comment delivery rules storage section 340. The comment delivery rules may be established in association with contents identifying information which identifies contents, or may be established in association with user identifying information which identifies users, or may be established in association with both of these. Comment attribute information that is associated with contents identifying information, and relates to the comments that are to be delivered together with the contents that are shown in that associated contents identifying information is stored in the comment delivery rules storage section 340. For example, the gender of a user may be recorded in the comment delivery rules storage section 340 as comment attribute information for a comment that is to be delivered together with particular contents. In this case, comments in which a gender which matches the gender recorded in the comment delivery rules storage section 340 has been recorded as comment attribute information are extracted, and delivered to the user terminals 400. Previously established rules may also be used for the comment delivery rules. Moreover, it is also possible to employ a method in which specified comment delivery rules are able to be applied as a result of the user terminals 400 receiving comment delivery rules input from users, and then transmitting the input comment delivery rules to the comment server 300, and storing them in the comment delivery rules storage section 340. It is also possible for the comment delivery rules to be set using compound conditions which are created by combining the attributes of a plurality of comments, or for a delivery ratio for each set of comment attributes to be determined. For example, the comment delivery rules may be determined in a ratio of 70% formed by comments in which the gender in the comment attributes is male, and 30% formed by comments in which the gender is female.

The comment extracting section 350 extracts from the plurality of comment identifying information items stored in the comment attribute information storage section 320 comment identifying information for the comment attribute information that, according to the comment delivery rules stored in the comment delivery rules storage section 340, is to be delivered to the user terminal 400. In this manner, the comment extracting section 350 determines comment identifying information for comments having specific comment attributes without having to refer to the actual comments themselves which are stored in the comment storage section 310, but instead by referring to comment identifying information which is stored in the comment extracting section 350 itself Namely, in order to extract comments with which specific comment attribute information has been associated, it is not necessary for the comment extracting section 350 to read the information of the actual comment itself. Because of this, it is possible to reduce the processing load required for the extraction processing compared with when comment extraction processing is performed while comments which are in the form of, for example, a string of alphabetical characters, are being referred to.

The comment delivery section 360 reads from the comment storage section 310 comments which have been stored therein in correspondence with comment identifying information extracted by the comment extracting section 360, and delivers the read comments and comment attribute information stored in correspondence with the comment identifying information to the user terminal 400.

When contents are selected by the user terminal 400, the comment attribute information defining section 370 selects from among the plurality of items of comment attribute information the items of comment attribute information that are stored in association with the comments that are attached to those particular contents. The items of comment attribute information refer to the types of comment attribute information. The items of comment attribute information include, for example, items of information previously input by users, items of information decided for each set of contents and input by users temporarily, and the like. For example, the comment attribute information defining section 370 may select items of comment attribute information from among the plurality of items included in the user attribute information such as the users' handle name, date of birth, gender, blood type, address, and the like. Alternatively, if the contents being delivered are, for example, a live baseball game, the comment attribute information defining section 370 may receive items such as the team supported by the user, the predicted winner, the predicted score, and the like. Information about fixed contents is associated with their respective items of comment attribute information. If, for example, the item relates to gender, then the contents which correspond to that item is information showing either male or female. If the item relates, for example, to a predicted score, then the contents may be selected from various (i.e., unlimited) selection alternatives such as [1-3], [1-1], and [1-0].

The comment attribute information defining section 370 may select items of comment attribute information that have been determined for each item of contents, or it may select items of comment attribute information that match items input from a provider who creates or provides the contents that are stored in the contents storage section 210. Alternatively, the comment attribute information defining section 370 may receive items of comment attribute information from a user terminal 400 and, by selecting a received item, allow that user to select the item of comment attribute information associated with that comment. Moreover, it is also possible for the comment attribute information defining section 370 to select different items in accordance with the actual time when the contents are being played, and to provide these items to the user terminal 400. It is also possible for the comment attribute information defining section 370 to select a plurality of items of comment attribute information for a single comment, and to define the plurality of items of comment attribute information as being attached to the single comment.

The user terminal 400 is a computer device which plays the contents delivered from the contents server 200, and combines them with comments delivered from the comment server 300 and outputs the results. The user terminal 400 is provided with a contents receiving section 410, a comment receiving section 420, an output control section 430, an output section 440, an attribute information storage section 450, an input section 460, a comment attribute management section 470, and a comment transmitting section 480.

The contents receiving section 410 receives contents delivered from the contents server 200, and stores them in its internal storage section.

The comment receiving section 420 receives comments delivered from the comment server 300, and stores them in its internal storage section.

The output control section 430 combines contents received by the contents receiving section 410 with comments received by the comment receiving section 420 and outputs them to the output section 440.

The output section 440 includes a display unit which displays comments and video included in the contents, and a speaker or the like which outputs audio information included in the contents. FIG. 3 shows an example of a screen output to the output section 440. Video delivered from the contents server 200 and a comment 442 transmitted from another user terminal 400 and delivered by the comment server 300 are displayed superimposed one on top of the other in a play area 441 within the screen. The comment 442 delivered from the comment server 300 is displayed so that it scrolls smoothly over the video from the right to the left. As a result, while viewing the video, a user of this communication service is able to share comments which are input in accordance with the video content with other users, and thus achieve communication with other users.

Comments are input from users via the input section 460 into an input form 443. When a user clicks a send button 444, the comment that has been input into the input form 443, and also the comment input time, video identifying information, and user identifying information and the like are transmitted to the user management server 100 and the comment server 300.

A comment list display area 445 is an area where comments input from a plurality of users are displayed. Listed comments are received from the comment server 300 by the comment receiving section 420 of the user terminal 400, and are stored in a storage area of the comment receiving section 420. Numbers 445a which show the submission sequence of each comment, usernames 445b of the users who input the comments, comment submission times 445c showing when the comments were sent, and portions 445d of the submitted comments are displayed in the sequence of the actual time at which they were submitted in the comment list display area 335.

It is also possible for the output control section 430 to alter the display of a comment which has been synchronized with the playing of contents in accordance with the comment attribute information belonging to the comment. For example, control may be performed such that comments whose comment attributes show a male user are displayed in blue, while comments whose comment attributes show a female user are displayed in pink.

Comment attribute information showing the attributes of comments transmitted by the user terminals 400 are stored in the attribute information storage section 450. Comment attribute information that matches the item selected by the comment attribute information defining section 370 of the comment server 300 is stored in the attribute information storage section 450. For example, when a user terminal 400 logs in to the user management server 100, user attribute information which is transmitted from the attribute information transmitting section 120 of the user management server 100 may be received by the comment attribute management section 470, and stored in the attribute information storage section 450. Alternatively, it is also possible for comment attribute information input by a user using the input section 460 to be stored by the comment attribute management section 470 in the attribute information storage section 450.

The input section 460 is an input device such as a keyboard or a mouse. Comments are input by a user via the input section 460 in response to contents which are played on its own host terminal.

The comment attribute management section 470 manages comment attributes which are attached to comments transmitted by the comment transmitting section 480. When a user terminal 400 selects contents stored in the contents server 200 and transmits a delivery request for the selected contents to the contents server 200, the comment attribute management section 470 reads from the contents server 200 thread identifying information which identifies the thread in which the comments attached to the requested contents is stored. The comment attribute management section 470 transmits to the comment server 300 this thread identifying information which it has read. Next, the comment attribute management section 470 receives from the comment server 300 information showing the items of comment attribute information that have been selected by the comment attribute information defining section 370 in accordance with this thread identifying information, and that have been provided for the comments which are attached to those contents. The comment attribute management section 470 stores in the attribute information storage section 450 the items of comment attribute information which it has received from the comment attribute information defining section 370. By doing this, comment attribute information for the selected items is stored in the attribute information storage section 450. When a comment is input into the input section 460, this comment attribute information is associated with the input comment and is transmitted to the comment server 300, and is stored in the storage area for the corresponding thread in the comment storage section 310.

When an item of comment attribute information input by a user has been selected by the comment attribute information defining section 370 of the comment server 300, the comment attribute management section 470 receives the comment attribute information input into the input section 460 by the user of its own host terminal, and causes the input comment attribute information to be stored in the attribute information storage section 450. For example, if the delivered contents are a live baseball game, information showing which of the two teams playing the user supports is input into the input section 460. The comment attribute management section 470 stores the information showing the supported team in the attribute information storage section 450 as comment attribute information. By doing this, it is possible, for example, to encourage communication between users who are supporting the same team during a live baseball game broadcast. Moreover, it is also possible for the comment attribute management section 470 to store the user attribute information transmitted from the user management server 100 in the attribute information storage section 450 as comment attribute information.

When a comment is input in response to the playing of contents, the comment transmitting section 480 transmits the input comments and the comment attribute information stored in the attribute information storage section 450 to the comment server 300.

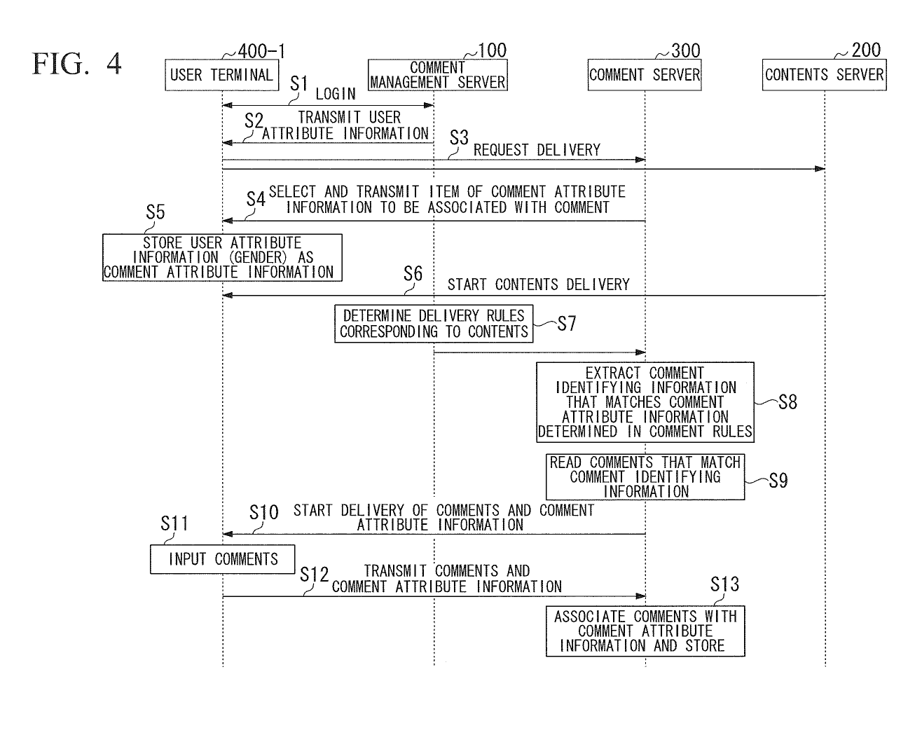

Next, an example of an operation of the communication system 1 according to the present embodiment will be described. FIG. 4 is a sequence diagram showing an example of an operation of the communication system 1.

The user terminal 400-1 makes a login request by transmitting user account information which has been input by a user to the user management server 100. The user management server 100 performs the login processing by collating the user account information transmitted from the user terminal 400-1 with the user account information stored in the user information storage section 110 (step S1). The attribute information transmitting section 120 of the user management server 100 reads user attribute information corresponding to the users who have successfully logged in from the user information storage section 110, and transmits it to the user terminal 400-1 (step S2). The comment attribute management section 470 of the user terminal 400-1 receives the user attribute information transmitted from the user management server 100, and stores it in a storage area in the comment attribute management section 470.

The user terminal 400-1 transmits a comment delivery request to the comment server 300, and transmits a contents delivery request to the contents server 200 (step S3).

The comment attribute information defining section 370 of the comment server 300 selects the item of comment attribute information which corresponds to the contents for which the contents delivery request was transmitted by the user terminal 400-1, and transmits information showing the selected item to the user terminal 400-1 (step S4). For example, if an item in the user attribute information which shows gender is selected, the comment attribute management section 470 of the user terminal 400-1 causes information about items showing gender which are included in the user attribute information which was transmitted from the user management server 100 in step S2 and was stored in the storage area in the comment attribute management section 470 to be stored in the attribute information storage section 450 as comment attribute information (step S5). The contents server 200 starts to deliver contents in accordance with the contents delivery request transmitted from the user terminal 400-1 (step S6).

Next, the user management server 100 determines those comment delivery rules from among the plurality of comment delivery rules stored in the comment delivery rules storage section 340 of the comment server 300 that match the contents identifying information for the contents to be transmitted to the user terminal 400-1 and the user identifying information of the user terminal 400-1 (step S7). For example, if a delivery rule is established that sets the gender item in the user attributes as a content attribute for the contents to be transmitted to the user terminal 400-1, the user management server 100 reads the gender that corresponds to the user of the user terminal 400-1 from the user information storage section 110. If the gender corresponding to that user is female, then the user management server 100 determines that comments to which comment attributes which show female have been attached are to be delivered to the user terminal 400-1. The comment extracting section 350 reads from the comment attribute information storage section 320 comment identifying information that matches the comment attribute information set in the comment delivery rules determined by the user management server 100 (step S8). The comment extracting section 350 reads the comments that correspond to the read comment identifying information from the comment storage section 310 (step S9). The comment delivery section 360 delivers the comments read by the comment extraction section 350 and the comment attribute information that corresponds to those comments to the user terminal 400-1 (step S 10). The output control section 430 of the user terminal 400-1 causes the comments delivered from the comment server 300 and the comments delivered from the contents server 200 to be output to the output section 440. Thereafter, when comments are transmitted from a plurality of user terminals 400, the comment server 300 performs the same processing as that of step S7 and step S8, and delivers the comments in real time.

When comments are input from users into the input section 460 (step S11) in accordance with the contents output by the output section 440 of the user terminal 400-1, the comment transmitting section 480 reads the comment attribute information stored in the attribute information storage section 450. The comment transmitting section 480 then attaches the read comment attribute information to the comments input in step S10, and transmits them to the comment server 300 (step S12). The comment information registering section 330 of the comment server 300 receives the comments and the comment attribute information transmitted from the user terminal 400-1, and associates them with the comment storage section 310 and the comment attribute information storage section 320, and stores them therein (step S13).

Note that in the present embodiment, the comment server 300 has been provided with the comment attribute information storage section 320 and the comment attribute information defining section 370, and the like, however, it is also possible to furnish an independent server device with the functions of these sections, and provide this as a comment attribute information management server.

Moreover, the attributes which are attached to the comments may, in addition to the above described user attribute information and the like, be, for example, favorite hobbies of users, temporary responses to a question which has been asked, and the like, or information that is determined on the basis of the user's behavior history. In this case, for example, the attributes attached to comments may be obtained by determining the favorite hobbies of users based on the contents viewing history of the users, and by then using information which shows the favorite hobbies thus determined. Alternatively, it is also possible to determine these attributes using contents viewing time periods.

In this operational example of the present embodiment, a case has been described in which, in step S7, the user management server 100 determines the comment delivery rules, however, it is also possible for the comment extracting section 350 of the comment server 300 to determine the comment delivery rules and then extract comment identifying information that conforms with the determined comment delivery rules from the comment attribute information storage section 320.

As has been described above, according to the present embodiment, it is possible to limit the comments that are delivered to a user terminal 400 in accordance with the attributes attached to those comments. By doing this, it is possible to reduce the processing load on the comment server 300 which is delivering the comments, the load on the network between comment server 300 and the user terminals 400 over which the comments are delivered, and the processing load on the user terminal 400-1 which is receiving the delivered comments. Because it is also possible to reduce the number of comments that are displayed on a user terminal 400, the number of displayed comments can be restricted to a number that a user is able to more easily comprehend. Moreover, because it is possible for comments to be shared between users who have the same attributes, high-quality communication between those users about relevant contents can be anticipated. Furthermore, if the provider of a communication service establishes comment attributes for the comments that are delivered as comment delivery rules, then it becomes possible to provide a communication site that conforms to the provider's intention.

Note that it is also possible to record a program that achieves the functions of the processing sections of the present invention on a computer-readable recording medium, and to provide a communication service by causing a computer system to read and execute the program recorded on this recording medium. Note that the term ‘computer system’ used here includes both OS and hardware such as peripheral devices and the like.

Moreover, ‘computer system’ may also include a WWW system which is provided with a homepage providing environment (or display environment). Moreover, the term ‘computer readable recording medium’ also refers to portable media such as flexible disks, magneto-optical disks, ROM, and CD-ROM and the like, and storage devices such as hard disks that are built into a computer system. Furthermore, ‘computer readable recording medium’ also includes devices that hold a program for a fixed time such as the internal volatile memory (RAM) in a computer system which forms the server or client when the program is transmitted via a network such as the Internet or via a communication line such as a telephone line.

Moreover, the aforementioned program may also be transmitted from a computer system in which the program is stored on a storage device or the like to another computer system via a transmission medium, or via a transmission wave within the transmission medium. Here, the term ‘transmission medium’ which transmits the program refers to a medium having a function of transmitting information such as a network such as the Internet or a communication line such as a telephone line. Moreover, the above described program may also be designed to fulfill a portion of the above described functions. Furthermore, the aforementioned program may also achieve the above described functions in combination with a program which is already recorded on the computer system, or may be what is known as a differential file (i.e., a differential program).

### INDUSTRIAL APPLICABILITY

The present invention can be used in a communication service in which comments which are input in accordance with the progress of contents which are played on a plurality of user terminals which are connected together via a network are shared between the plurality of users, and makes it possible to restrict the number of comments displayed on a user terminal to a number that a user is able to more easily comprehend, and that enables communication between users to proceed more smoothly. REFERENCE SYMBOLS
1 Communication system
100 User management server
110 User information storage section
120 Attribute information transmitting section
200 Contents server
210 Contents storage section
220 Contents delivery section
300 Comment server
310 Comment storage section
320 Comment attribute information storage section
330 Comment information registering section
340 Comment delivery rules storage section
350 Comment extracting section
360 Comment delivery section
370 Comment attribute information defining section
400 User terminal
410 Contents receiving section
420 Comment receiving section
430 Output control section
440 Output section
450 Attribute information storage section
460 Input section
470 Comment attribute management section
480 Comment transmitting section

1. A communication system comprising: a plurality of user terminals; and
a comment server that stores in a comment storage section comments which are transmitted from the user terminals in response to contents which are played on the user terminals, and delivers the comments to the plurality of user terminals to be displayed thereon, wherein
the comment server includes:
a comment attribute information storage section that stores comment identifying information which identifies the comments stored in the comment storage section and comment attribute information which shows attributes of the comments in association with each other;
a comment information registering section that receives the comments and the comment attribute information associated with the comments transmitted from the user terminals, and stores the comment identifying information for the comments and the comment attribute information in association with each other in the comment attribute information storage section;
a comment extracting section that extracts the comments which are indicated by the comment attribute information to be delivered to the user terminals from among the plurality of comments stored in the comment storage section; and
a comment delivery section that delivers to the user terminal the comments extracted by the comment extracting section, and wherein the user terminal includes:
an attribute information storage section that stores the comment attribute information showing attributes of the comments to be transmitted:
an input section that receives the comments input in response to the contents being played; and
a comment transmitting section that transmits to the comment server the comments input in response to the contents being played, and the comment attribute information stored in the attribute information storage section.

2. The communication system according to claim 1, wherein:
the comment server includes a comment attribute information defining section that selects, from a plurality of items of the comment attribute information, an item of comment attribute information to be stored in association with comment attached in response to the contents when the contents are selected by the user terminal; and
the attribute information storage section in the user terminal stores the comment attribute information which matches the item selected by the comment attribute information defining section.

3. The communication system according to claim 1, wherein:
the communication system includes a user management server which stores user attribute information showing attribute of the user corresponding to the user terminal; and
the attribute information storage section in the user terminal stores the user attribute information read from the user management server as the comment attribute information.

4. The communication system according to claim 1, wherein the user terminals includes a comment attribute management section that receives the comment attribute information input by the user, and stores the input comment attribute information in the attribute information storage section.

5. The communication system according to claim 1, wherein:
the comment delivery section in the comment server delivers to the user terminals the comments extracted by the comment extracting section, and the comment attribute information stored in association with the comment; and
the user terminal includes an output control section that alters displaying of the comment in response to the comment attribute information stored in association with the comment.

6. A communication method in a communication system comprising a plurality of user terminals, and a comment server that has a comment storage section which stores comments transmitted from the user terminals in response to contents which are played by the user terminals, and delivers the comments to the plurality of user terminals, comprising:
receiving, in the comment server, the comments and comment attribute information which is associated with and indicative of attributes of the comments from the user terminals;
storing, in the comment attribute information storage section, comment identifying information which identifies the comments and the comment attribute information in association with each other;
extracting, in the comment server, the comments which are indicated by the comment attribute information to be delivered to the user terminals from among the plurality of comments stored in the comment storage section;
delivering, in the comment server, the extracted comments to the user terminals;
storing, in the user terminals, the comment attribute information showing attributes of the comments to be transmitted in the attribute information storage section:
receiving, in the user terminals, the comments input in response to the contents being played; and
transmitting, in the user terminals, the comments input in response to the contents being played, and the comment attribute information stored in the attribute information storage section to the comment server.

7. A comment server comprising:
a comment storage section which stores comments transmitted from a plurality of user terminals in response to content which is played by the user terminals;
a comment attribute information storage section which stores comment attribute information showing attributes of the comments in association with the comments stored in the comment storage section;
a comment extracting section which extracts the comments associated with selected item of the comment attribute information in the comment attribute information storage section from among the plurality of comments stored in the comment storage section; and
a comment delivery section which delivers the comments extracted by the comment extracting section to the user terminal.

8. The comment server according to claim 7, comprising a comment information registering section which receives the comments and the comment attribute information associated with the comments from the user terminals, and stores the received comment attribute information in association with the received comments in the comment attribute information storage section;

9. The comment server according to claim 7, comprising a comment attribute information defining section which selects the item of the comment attribute information selected in the comment extracting section in response to the content played by the user terminal.

10. A comment delivery method comprising the steps of:
storing, in a comment storage section, comments transmitted from a plurality of user terminals in response to content which is played by the user terminals;
storing, in a comment attribute information storage section, comment attribute information showing attributes of the comments in association with the comments stored in the comment storage section;
extracting, by a comment extracting section, the comments associated with selected item of the comment attribute information in the comment attribute information storage section from among the plurality of comments stored in the comment storage section; and
delivering the comments extracted by the comment extracting section to the user terminal.

11. A computer readable media storing a program for making a computer functioning as a comment server execute the steps of:
storing, in a comment storage section, comments transmitted from a plurality of user terminals in response to content which is played by the user terminals;
storing, in a comment attribute information storage section, comment attribute information showing attributes of the comments in association with the comments stored in the comment storage section;
extracting, by a comment extracting section, the comments associated with selected item of the comment attribute information in the comment attribute information storage section from among the plurality of comments stored in the comment storage section; and
delivering the comments extracted by the comment extracting section to the user terminal.
